(19) United States
(12) Patent Application Publication
(10) Pub. No.: US 2004/0064199 A1
(43) Pub. Date: Apr. 1, 2004

(54) Information processing apparatus, control method, program, and storage medium

(75) Inventors: Junichi Asoh, Tokyo-to (JP); Takenobu Nakao, Tokyo-to (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/629,955

(22) Filed: Jul. 30, 2003

(30) Foreign Application Priority Data
Aug. 9, 2002 (JP) 2002-233302

(51) Int. Cl. G05B 11/01

(52) U.S. Cl. 700/19

(57) ABSTRACT

To implement actions associated with built-in buttons trough operations from an external device.

An information processing apparatus 10 includes an output portion 205 for outputting information from the information processing apparatus to the external; a built-in button 185 for controlling the output portion 205 in response to an input from the external; a first input information receiving portion 140 for receiving external input information from an external input device 50 having keys different from the built-in button 185, the external input information being information input to any of the keys; and a controlling portion 150 for initiating the same processing as that performed when the built-in button 185 is entered if it is determined that the external input information matches preset configuration information.

### BACKGROUND OF THE INVENTION

1. Field of the Invention

The present invention relates to an information processing apparatus, control method, program, and storage medium and in particular to an information processing apparatus, control method, program and storage medium for controlling an apparatus through a keyboard.

2. Background Art

Devices such as personal computers have been in use that have built-in buttons for adjusting output volume or screen brightness. Those built-in buttons are useful in that they allow users to adjust such outputs without activating application programs and the like.

However, such devices do not allow outputs to be controlled through the operation of an external keyboard that has no built-in buttons.

### SUMMARY OF THE INVENTION

The invention, therefore, has the object of providing an information processing apparatus, a control method, a program, and a storage medium that can solve the above-mentioned problem. The object is attained by combination of features described in independent claims in Claims. Dependent claims further define advantageous specific examples of the invention.

According to a first embodiment of the present invention, there are provided an information processing apparatus having an input device, a method for controlling the apparatus, a program for controlling the apparatus, and a storage medium on which the program is recorded, wherein the information processing apparatus comprises an output portion for outputting information to the information processing apparatus to the external; a built-in button for controlling the output portion; a first input information receiving portion for receiving external input information input into a key from an external input device having keys different from the built-in button; and a controlling portion for initiating the same processing as that performed when said built-in button is entered if the external input information matches preset configuration information.

According to a second embodiment of the present invention, there are provided an information processing apparatus, a method for controlling the apparatus, a program for controlling the apparatus, and a storage medium on which the program is recorded, wherein the information processing apparatus comprises a first input information receiving portion for receiving code information specified in a code system different from the code system for information input to built-in buttons, the code information being information input to a plurality of keys different from the built-in buttons; a converting portion for converting the code information into the built-in button input information if it is determined that the code information matches preset configuration information; and a controlling portion for initiating the same processing as that performed when certain one or more of the built-in buttons are entered if the converted input information matches the information input to the certain one or more of the built-in buttons.

According to a third embodiment of the present invention, there are provided an information processing apparatus, a method for controlling the apparatus, a program for controlling the apparatus, and a storage medium on which the program is recorded, wherein the information processing apparatus comprises: a first input information receiving portion for receiving code information associated with depression of any of the plurality of keys detected through matrix scanning; a second input information receiving portion for detecting input information from the built-in buttons different from the plurality of keys; a converting portion for converting the code information into the built-in button input information if it is determined that the code information matches preset configuration information; and a controlling portion for initiating the same process as that performed when certain one or more of the built-in buttons are entered if the converted input information matches the input information to the certain one or more of the built-in buttons.

The summary provided above is not exhaustive enumeration of the indispensable features of the present invention. Any sub-combinations of features mentioned above can fall in the scope of the present invention.

### BRIEF DESCRIPTION OF THE DRAWINGS

FIG. 1 shows a functional block-diagram of an information processing apparatus 10;

FIG. 2 shows an operation flow in the information processing apparatus;

FIG. 3 shows an example of conversion in the converting portion 160;

FIG. 4 shows built-in buttons 185 and their actions associated corresponding to external input information from an external keyboard 50; and

FIG. 5 shows an example of a hardware configuration of the information processing apparatus.

### DETAILED DESCRIPTION OF EMBODIMENTS

The present invention will be described with respect to embodiments of the present invention. However, the embodiments described below does not limit the present invention set forth in the claims and all combinations described with respect to the embodiments are not necessarily requited for the inventive means for solving the problems.

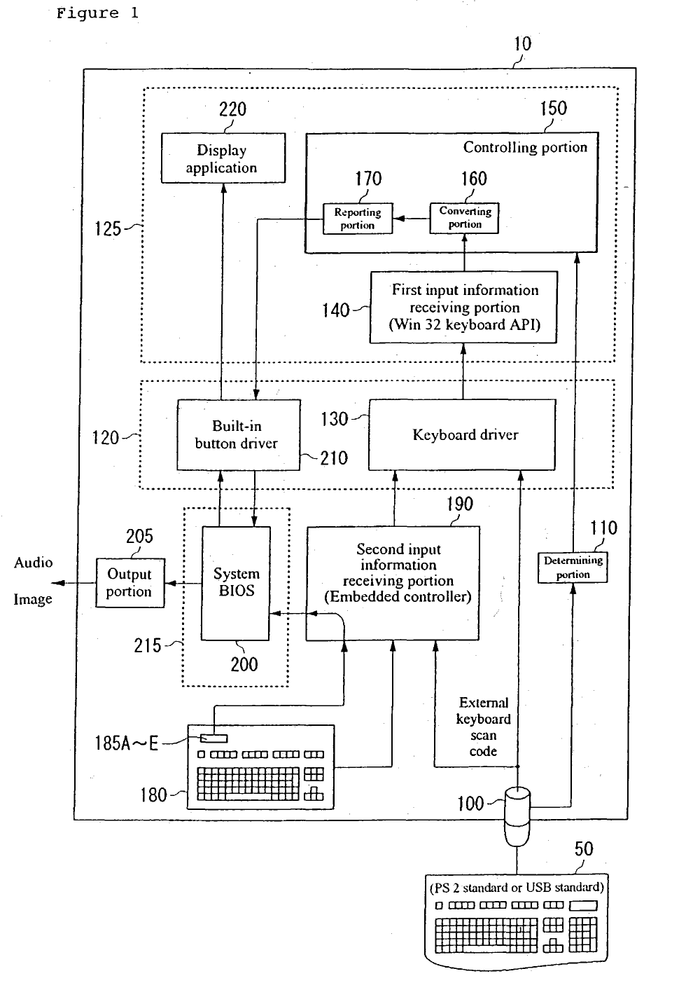

FIG. 1 shows a functional block diagram of an information processing apparatus 10. In the information processing apparatus 10 according to the present embodiment, when input information received from an external source through an external keyboard 50, without built-in buttons 185, matches preset information, the same action as that performed when a built-in button 185 for a built-in button driver 210 is depressed. The information processing apparatus 10 comprises a connecting portion 100, a determining portion 110, a keyboard driver 130, a first input information receiving portion 140, a controlling portion 150, a built-in keyboard 180, a second input information receiving portion 190, a system BIOS 200, an output portion 205, a driver 210, and a display application 220. A PS2- or USB-compliant external keyboard 50 which is an external input device having a number of keys is coupled to the information processing apparatus 10.

The information processing apparatus 10 provides the functions of these through a set of kernel-level processes 120 and a set of user-level processes 125 performed by an operating system (hereinafter abbreviated to OS) that controls the operations of application programs, and firmware 215 and hardware.

The connection portion 100 removably connects the external keyboard 50 to the information processing apparatus 10 and transfers the state of the connection and communication with the external keyboard 50 to the determining portion 110. The connecting portion 100 receives from the external keyboard 50 external keyboard scan code information indicating depression of keys in the external keyboard 50 that is detected by matrix scanning and generates and provides an interrupt to the OS to send it to the keyboard driver 130.

In an alternative example, the connecting portion 100 may send the external keyboard scan code information to the keyboard driver 130 through the second input information receiving portion 190. For example, if the external keyboard 50 is connected through a PS-2- or USB-compliant connector, the connecting portion 100 may cause the second input information receiving portion 190 to read external keyboard scan codes.

The determining portion 110 determines whether or not the external keyboard 50 is connected to the information processing apparatus 10 on the basis of the state of connection and communication with the external keyboard 50 that it received from the connection portion 100 and, if not connected, sends a command for halting conversion of input information to the controlling portion 150.

The keyboard driver 130 is implemented as a set of kernel-level processes 120. The connecting portion 100 receives keyboard scan code information from the second input information receiving portion 190 and provides it to the first input information receiving portion 140.

The first input information receiving portion 140 is a service module operating in user mode and is implemented as a set of user-level processes 125. The first input information receiving portion 140 receives the external keyboard scan code information from the keyboard driver 130 and provides it to the controlling portion 150 through a standard application programming interface (API) provided by the OS. The first input information receiving portion 140 may use a function called the Win32 keyboard API if the OS is Windows®, for example.

The controlling portion 150 has a converting portion 160 and a reporting portion 170. Unless the converting portion 160 receives an input information conversion halt command from the determining portion 110, it determines whether or not external keyboard scan code information it received from the first input information receiving portion 140 matches preset information. If the converting portion 160 determines that they match with each other, then it converts the external keyboard scan code information into information that would be input into the built-in button 185 and sends it to the reporting portion 170. When receiving the input information, the reporting portion 170 sends it to the built-in button driver 210 to use the system BIOS 200, which is firmware 215, to control the output of information.

The controlling portion 150, converting portion 160, and reporting portion 170 are implemented as a set of user-level processes 125.

The built-in keyboard 180 has built-in buttons 185A to 185E. When any of the built-in buttons 185A to 185E receives an input from the external, then the built-in keyboard 180 sends to the second input information receiving portion 190 information input into the built-in button 185 for indicating which of the built-in buttons 185A to 185E has received. The built-in keyboard 180 may have a plurality of keys different from the built-in buttons 185A to 185E. In that case, information input into any of the plurality of keys is sent to the second input information receiving portion 190.

The second input information may be implemented by a microcomputer such as an embedded controller, for example. The second information receiving portion 190 monitors the built-in buttons 185 by periodically polling them, receives from the built-in keyboard 180 information input into a built-in button 185 and sends it to the system BIOS 200.

The second input information receiving portion 190 receives from the built-in keyboard 180 information about inputs into any of a plurality of keys which are different from the built-in buttons 185A to 185E and sends it to the keyboard driver 130.

The second input information receiving portion 190 in the present embodiment detects information input into a built-in button 185 by using a method that differs from matrix scanning. For example, the second input information receiving portion 190 may detects depression of a built-in button 185 by directly reading the on/off state of switches, each of which is associated with each of the built-in buttons 185A to 185E. Alternatively, the second input information receiving portion 190 may detect by matrix scanning that generates code information specified in a code system different from the one which the external keyboard scan code information is compliant with.

In another example, the second input information receiving portion 190 may detect depression of a built-in button 185 by using a method other than polling. For example, the second input information receiving portion 190 may receive an interrupt from the built-in keyboard 180 to detect depression of a built-in button 185 and issue an interrupt to the OS through the system BIOS 200 to transfer depression of the built-in button 185 to the built-in button driver 210.

The system BIOS 200 is implemented as firmware 215 that operates without using the functionality of the OS and controls the output of information such as audio and images from the information processing apparatus 10 and provides other functions such as power management. The firmware 215 is software stored in a non-volatile memory of the information processing apparatus, for example, for controlling the hardware of the information processing apparatus.

The system BIOS 200 receives information input into a built-in button 185 from the second input information receiving portion 190 or the controlling portion 150 and controls outputs according to that input information. The system BIOS 200 sends information output parameters to the output portion 205 in response to a request from the output portion 205. The system BIOS 200 sends information input into a built-in button 185 to the built-in button driver 210 when a function of the OS is required for providing a control responsive to that built-in button 185 input information.

For example, if the system BIOS 200 receives built-in button 185 input information for turning the output sound volume up from the second input information receiving portion 190, the system BIOS 200 increases the value that increase the volume value stored in the output portion 205.

The output portion 205 is implemented by hardware. It stores information output parameters such as the sound volume and the brightness of image display and outputs information to the outside of the apparatus according to the output parameters. The output portion 205 changes the output parameters in response to an instruction from the system BIOS 200.

The built-in button driver 210 is implemented as a set of kernel-level processes 120. It receives converted input information from the reporting portion 170. The built-in button driver 210 also receives information input into a built-in button 185 from the system BIOS 200. If an action to be performed in response to converted information requires the system BIOS 200, the built-in button driver 210 sends that converted input information to the system BIOS 200. On the other hand, if an action to be performed in response to converted input information does not require the system BIOS 200 or information input into a built-in button 185 is received from the system BIOS 200, the built-in button driver 210 performs the action by using the API of the OS and other functions. In such a case, the built-in button driver 210 sends an image display instruction to the display application 220 as needed.

The display application 220 externally displays an image according to the image display instruction received from the built-in button driver 210. For example, if the system BIOS 200 increases the output sound volume, the display application 220 externally displays a graph or an icon as an image indicating that the sound volume has been increased.

As described above, the information processing apparatus 10 receives external input information specified in external keyboard scan code information, which is a code system different form the one for information input into built-in button 185, from the external keyboard 50. If the external input information matches preset information, it is converted into information that would be input into the built-in button 185. Then the information processing apparatus 10 performs the same action as the action, information output control for example, that would be performed when the built-in button 185 is entered.

In this way, the information processing apparatus 10 can made the convenient manipulation of the built-in buttons 185 specific to the built-in keyboard 180 available to a user through an operation on the external keyboard 50.

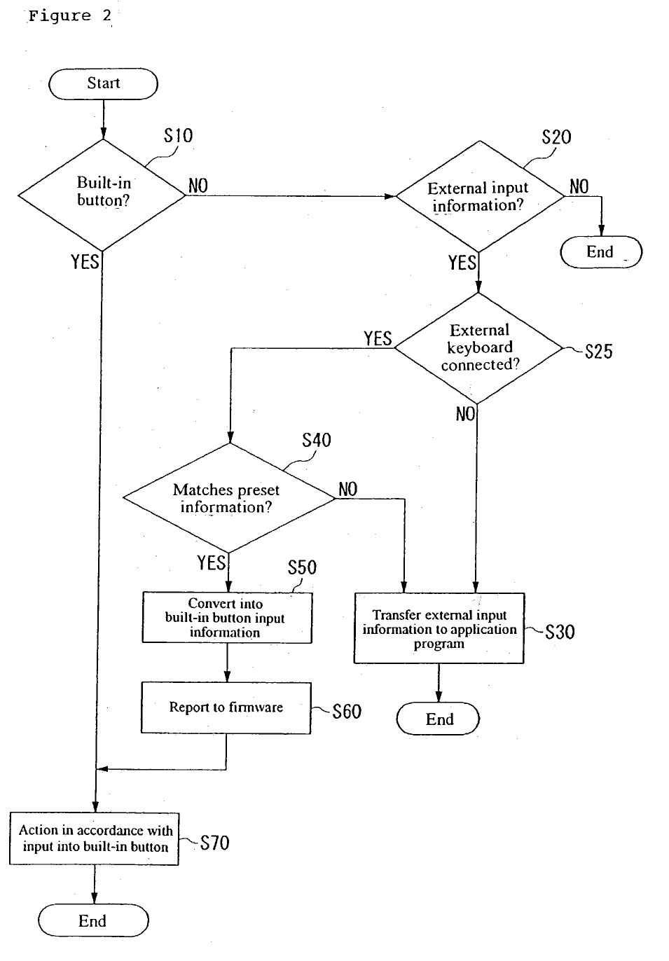

FIG. 2 shows an operation flow in the information processing apparatus 10. The second input information receiving portion 190 determines whether or not a built-in button 185 is entered (S10). If it determines that no built-in button 185 is entered (determination at S10 is NO), the first input information receiving portion 140 determines whether or not it has received external keyboard scan code information, which is external input information, from the external keyboard 50 (S20). If it determines that it has received no external keyboard scan code information (determination at step S20 is NO), the information processing apparatus 10 ends the process.

Then the determining portion 110 determines whether or not the external keyboard 50 is connected to the information processing apparatus 10 and, if it determines that the external keyboard is not connected (determination at S25 is NO), the converting portion 160 abandons the attempt to convert external keyboard scan code information and transfers the external input information to another application program (S30). The connecting portion 100 of the information processing apparatus 10 may have a switch, which is a connector to the external keyboard 50, and the determining portion 110 may detect the ON/OFF state of the switch to determine whether or not the external keyboard 50 is connected, for example. Alternatively, the determining portion 110 causes the information processing apparatus 10 to perform test communication with the external keyboard 50 or communication for synchronization with the external keyboard 50 and determines on the basis of the result of the communication whether or not the external keyboard 50 is available to communicate with the information processing apparatus 10.

If it is determined that the external keyboard 50 is connected to the information processing apparatus 10 (determination at step S25 is YES), the converting portion 160 determines whether or not the external keyboard scan code information matches preset information (S40). If the converting portion 160 determines that there is no match (determination at step S40 is NO), it performs the process at S30. If it determines that there is a match (determination at step 40 is YES), the converting portion 160 converts the external keyboard scan code information into the built-in button 185 input information (S50).and provides the converted input information to the system BIOS 200, which is firmware (S60).

The system BIOS 200 performs an action according to the input into the built-in button 185 if the built-in button 185 is depressed (determination at step S10 is YES) or if it receives the converted information (S70).

The information processing apparatus 10 may perform the process described above periodically or each time a key or built-in button 185 is depressed.

As described above, the information processing apparatus 10 can perform the same action as the one that would be performed when a built-in button is depressed if external input information matches preset information. Thus, the user can use the convenient facilities such as built-in buttons 185 even while he or she is operating the information processing apparatus 10 through the external keyboard 50.

While the information processing apparatus 10 converts external input information on receiving it from the external keyboard 50 (determination at step S20 is YES) in the present embodiment, the information processing apparatus 10 may determine that it has received external input information (determination at step S20 is YES) when a predetermined combination of keys are depressed among a number of keys that differ from the built-in buttons 185 in the built-in keyboard 180 in an alternative embodiment. In that case, the information processing apparatus 10 converts input information from the built-in keyboard 180 into built-in button 185 input information whether the external keyboard 50 is connected or not.

In such an example, a user can manipulate the function associated with a built-in buttons 185 through a key different from the built-in button 185 while he or she is operating the built-in keyboard 180. For example, the user can perform an operation associated with a built-in button 185 without moving his or her hands from the touch typing home position.

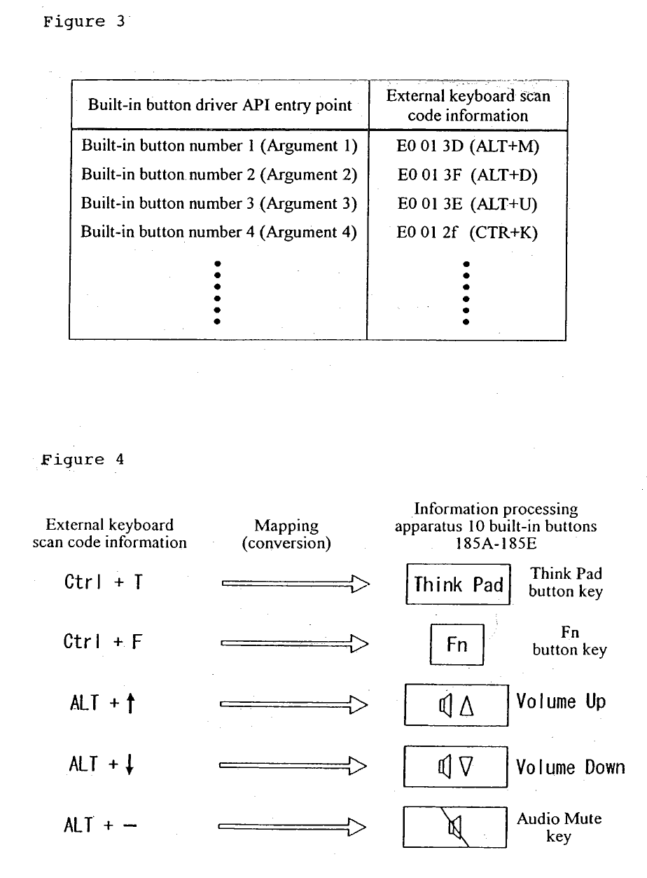

FIG. 3 shows an example of conversion by the converting portion 160. The converting portion 160 associates and stores built-in button driver API entry points, which is an example of built-in button 185 input information, with external keyboard scan code information specified in a code system which is different from that of the built-in button 185 input information and is an example of preset information used by the converting portion 160 for determination.

The converting portion 160 receives the eternal keyboard scan code information from the first input information receiving portion 140 through an API of the OS provided by the first input information receiving portion 140. For example, the converting portion 160 receives “E0013D” as external keyboard scan code information when the “M” key on the external keyboard 50 is depressed together with the “ALT” key. The converting portion 160 finds that the external keyboard scan code information received from the first input information 140 matches “E0013D” shown in FIG. 3 and identifies “built-in button number 1 (argument 1)”,which is a built-in button driver API entry point.

Then the reporting portion 170 identifies the address of an executable code in the built-in button driver 210 on the basis of “built-in button 1 (argument 1)” and cause the program starting from the identified address. This program is the same as the one that is executed when the built-in button 185 is depressed. This means that the converting portion 160 has been able to convert the external keyboard scan code information into the address of the program that is executed when the built-in button 185 is depressed.

In this way, the converting portion 160 can convert external keyboard scan code information, which is external input information, into built-in button 185 input information in response to an input in the external keyboard 50 to cause the same action as the one that would be performed when the built-in button 185 is depressed.

FIG. 4 shows an example of built-in buttons 185 and their actions corresponding to external input information from the external keyboard 50. “Ctrl”, “ALT”, “T”, “F”, “↑”, “⇓”,and “−” in FIG. 4 represent the depressions of a control key, an alternative key, the T key, the F key, the cursor up key, the cursor down key, and the minus key, respectively. The symbol “+” represents that a combination of keys are depressed at a time.

The “ThinkPad®” key, which is a built-in button 185A, is used for activating a predetermined application. The “Fn” button key, which is also a built-in key 185B, is used for activating an expanded function. The “Volume Up” key, which is a built-in button 185C, and the “Volume Down” key, which is a built-in button 185D, are used for turning up and down, respectively, the sound volume. The “Audio Mute” key, which is a built-in key 185E, is used for inhibiting audio output.

As can be seen from FIG. 4, when the information processing apparatus 10 determines that a predefined combination of keys among the plurality of keys, it can perform the same action as the action which is performed when the corresponding one of the built-in buttons 185A to 185E is depressed. For example, the information processing apparatus 10 can perform the action associated with the “Volume Up” key in response to the depression of the “Alt+556 ” keys on the external keyboard 50.

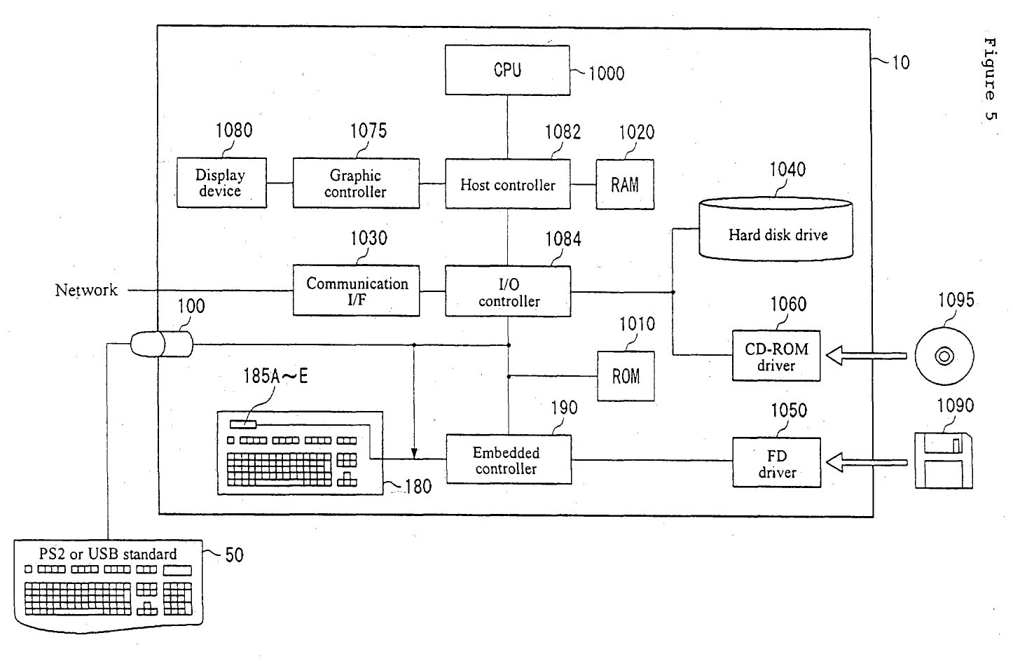

FIG. 5 shows an example of a hardware configuration of the information processing apparatus 10. The information processing apparatus according to the present embodiment consists of a CPU 1000 and a CPU-supporting portion including a RAM 1020, a graphic controller 1075, and a display device 1080 which are connected with one another, a input/output portion including a communication interface 1030, a hard disk drive 1040, and CD-ROM drive 1060, which are connected to the host controller 1082 through an input/output controller 184, a legacy input/output portion including a ROM 1010, a flexible disk drive 1050, and an embedded controller 190, which is an input/output chip, a built-in keyboard 180, and a connecting portion 100, which are connected to the input/output controller 1084. The embedded controller 190 acts as the first input information receiving portion 190 shown in FIG. 1.

The host controller 1082 connects the RAM 1020 with the CPU 1000 and the graphic controller 1075 which access the RAM at high transfer rates. The CPU 1000 operates according to programs stored in the ROM 1010 and the RAM 1020 to control each component. The ROM 1010 stores the system BIOS 2000 shown in FIG. 1 for controlling the output of information in combination with the CPU 1000. The graphic controller 1075 obtains image data generated by the CPU 1000 on a frame buffer provided in the RAM 1020 and displays it on the display device 1080. Alternatively, the graphic controller 1075 may include within it a frame buffer for storing image data generated by the CPU 1000.

The input/output controller 1084 connects the host controller 1082 with the communication interface 1030, the hard disk drive 1040, and the CD-ROM drive 1060, which are relatively fast input/out devices. The embedded controller 190 may be connected with the built-in keyboard 180. The communication interface 1030 provides communication with other apparatuses through a network. The hard disk drive 1040 stores programs and data used by the information processing apparatus 10. The CD-ROM drive 1060 reads a program or data from the CD-ROM 1095 and provides it to the embedded controller 190 through the RAM 1020.

Connected to the input/output controller 1084 are relatively slow input/output devices such as the ROM 1010, flexible disk drive 1050, and embedded controller 190, and the external keyboard 50, which communicates through the connecting portion 100. The ROM 1010 stores programs executed by the CPU 1000 on activation of the information processing apparatus 10 and programs dependent on the hardware of the personal computer main unit 110. The flexible disk drive 1050 reads a program or data from a flexible disk 1090 and provides it to the embedded controller 190 through the RAM 1020. Connected to the embedded controller 190 are the flexible disk 1090 and input/output devices such as the external keyboard 50 through the connecting portion 100 including a parallel port, serial port, keyboard port, and mouse port. Also connected to the embedded controller 190 are input/output devices such as the built-in keyboard 180. The built-in keyboard 180 has built-in buttons 185A to 185E and sends input information to the second input information receiving portion 190 in response to inputs from external sources.

A program for implementing the information processing apparatus 10 comprises a determining module, a keyboard driver, a first input information receiving module, a controlling and processing module, a converting module, a reporting module, a built-in button driver, a display application program, and an output module. These modules causes the information processing apparatus 10 to operate as the determining portion 110, keyboard driver 130, first input information receiving portion 140, controlling portion 150, processing portion 150, converting portion 160, reporting portion 170, built-in button driver 210, display application 220, and output portion.

The program to be supplied to the information processing apparatus 10 is stored in a storage medium such as a flexible disk 1090, CD-ROM 1095, or IC card and provided to the user. The program is read from the storage medium, installed into the hard disk drive 1040 through the embedded controller 190, and executed from the hard disk drive 1040.

The program and modules mentioned above may be stored in an external storage medium. The storage medium may be, besides a flexible disk 1090 and CD-ROM 1095, an optical storage medium such as a DVD and PD, magneto-optical storage medium such as MD, a tape medium, and a semiconductor memory such as an IC card.

Alternatively, a storage device such as a hard disk or RAM provided in a server system connected onto a private communication network or the Internet may be used as a storage medium for the program and the program may be provided to the information processing apparatus 10 over the network.

In summary, when the information processing apparatus 10 receives external input information, which is key input information, from an external input device having keys different from the built-in buttons of the information processing apparatus 10, the information processing apparatus 10 determines whether or not the external input information matches preset information. If the external input information matches the preset information, the information processing apparatus 10 can perform the same action as the one that it performs when a built-in button is depressed. In this way, the information processing apparatus 10 can make convenient functions associated with the built-in buttons available through operations on the external input devices.

According to the embodiments described above, the following information processing apparatus, control method, program, and recording are implemented.

As can be seen from the foregoing description, the present invention allows actions associated with built-in buttons to be implemented through operations from an external input device.

While the present invention has been described with respect to the embodiment, the technical scope of the present: invention is not limited to the one described in the present embodiment. Various modifications or improvements can be made to the embodiment described above. It will be apparent from the claims that embodiments to which such modifications and improvements are made also fall within the technical scope of the present invention.

1. An information processing apparatus having an input device, comprising:
an output portion for outputting information from said information processing apparatus to the external;
a built-in button for controlling the output portion in response to an input from the external;
a first input information receiving portion for receiving external input information from an external input device having keys different from the built-in button, said external input information being information input to any of said keys; and
a controlling portion for initiating the same processing as that performed when one or more of the built-in button are entered if the external input information matches preset configuration information.

2. The information processing apparatus according to claim 1, wherein said external input device is an external keyboard and said first input information receiving portion receives said external input information through the Application Programming Interface (API) of an operating system that manages the operation of application programs.

3. The information processing apparatus according to claim 1,
wherein said first input information receiving portion is a module operating in user mode on said operating system; said information processing apparatus detects said input information in said built-in button through firmware stored in a non-volatile memory of said information processing apparatus for controlling hardware of said information processing apparatus;
said controlling portion comprises a converting portion for converting said external input information into said built-in button input information; and
a reporting portion for reporting said converted input information to said firmware to cause said firmware to initiate the same processing as that performed when said built-in button is entered.

4. The information processing apparatus according to claim 1, wherein said first input information receiving portion receives said external input information from said external input device having said plurality of keys; and
a controlling portion for initiating the same processing as that performed when said built-in button is entered if it is determined that a predetermined combination of keys among said plurality of keys is entered.

5. An information processing apparatus having built-in buttons as an input device and processing information in response to information input to said built-in buttons, said information processing apparatus comprising:
a first input information receiving portion for receiving code information specified in a code system different from the code system for said built-in button input information, said code information being information input to a plurality of keys different from said built-in buttons;
a converting portion for converting said code information into said built-in button input information if it is determined that said code information matches preset configuration information; and
a controlling portion for initiating the same processing as that performed when certain one or more of said built-in buttons are entered if said converted input information matches said information input to said certain one or more of said built-in buttons.

6. The information processing apparatus according to claim 5, comprising a built-in keyboard having said built-in buttons and said plurality of keys;
an external input device having said plurality of keys; and
a determining portion for determining whether or not said external input device is connected; wherein
said converting portion converts said code information if it is determined that said external device is connected, or halts conversion of said code information if it is determined that said external input device is not connected.

7. The information processing apparatus according to claim 5, wherein said first input information receiving portion receives said code information from an operating system interrupted by depression of any of said plurality of keys; and
said information processing apparatus further comprises a second input information receiving portion for detecting the depression of any of said built-in buttons by periodically polling said built-in buttons.

8. The information processing apparatus according to claim 5, wherein said first input information receiving portion receives said code information from an operating system interrupted by depression of any of said plurality of keys; and
said information processing apparatus further comprises a second input information receiving portion for detecting depression of a key on the basis of an interrupt to said operating system.

9. An information processing apparatus having a plurality of keys and built-in buttons, comprising:
a first input information receiving portion for receiving code information associated with depression of any of said plurality of keys detected through matrix scanning;
a second input information receiving portion for detecting input information to said built-in buttons different from said plurality of keys;
a converting portion for converting said code information into said built-in button input information if it is determined that said code information matches preset configuration information; and
a controlling portion for initiating the same process as that performed when certain one or more of said built-in buttons are entered if said converted input information matches said input information to said certain one or more of said built-in buttons.

10. A control method, for controlling an information processing apparatus having an input device, comprising steps of:
outputting information from said information processing apparatus to the external;
controlling said output step in response to an input from the external to a built-in button;
receiving an external input information from an external input device having keys different from said built-in button, said external input information being information input through any of said keys; and
initiating the same processing as that performed when said built-in button is entered if it is determined that said external input information matches preset configuration information.

11. A control method, for controlling an information processing apparatus having a built-in button as an input device and processing information in response to information input into said built-in button, comprising steps of:
receiving code information specified in a code system different from a code system for said built-in button input information, said code information being information input to a plurality of keys different from said built-in buttons;
converting said code information into said built-in button input information if it is determined that said code information matches preset configuration information; and
initiating the same processing as that performed when certain one or more of said built-in buttons are entered if said converted input information matches said information input to said certain one or more of said built-in buttons.

12. A methods for controlling an information-processing apparatus having a plurality of keys and built-in buttons, comprising steps of:
receiving code information associated with depression of any of said plurality of keys detected through matrix scanning;
detecting input information to said built-in buttons different from said plurality of keys;
converting said code information into said built-in button input information if it is determined that said code information matches preset configuration information; and
initiating the same process as that performed when certain one or more of said built-in buttons are entered if said converted input information matches said input information to said certain one or more of said built-in buttons.

13. A program for using a computer to control an information processing apparatus having an input device, causing said computer to function as:
an output portion for outputting information from said information processing apparatus to the external;
a built-in button for controlling said output portion in response to an input from the external to a built-in button;
a first input information receiving portion for receiving an external input information from an external input device having keys different from said built-in button, said external input information being information input through any of said keys; and
a controlling portion for initiating the same processing as that performed when said built-in button is entered if it is determined that said external input information matches preset configuration information.

14. A method, for controlling an information processing apparatus having a built-in button as an input device and processing information in response to information input to said built-in button, causing said apparatus to function as:
a first input information receiving portion for receiving code information specified in a code system different from the code system for said built-in button input information, said code information being information input to a plurality of keys different from said built-in buttons;
a converting portion for converting said code information into said built-in button input information if it is determined that said code information matches preset configuration information; and
a control portion for initiating the same processing as that performed when certain one or more of said built-in buttons are entered if said converted input information matches said information input to said certain one or more of said built-in buttons.

15. A program for using a computer to control an information processing apparatus having a plurality of keys and built-in buttons, causing said computer to functions as:
a first input information receiving portion for receiving code information associated with depression of any of said plurality of keys detected through matrix scanning;
a second input information receiving portion for detecting input information to said built-in buttons different from said plurality of keys;
a converting portion for converting said code information into said built-in button input information if it is determined that said code information matches preset configuration information; and
a controlling portion for initiating the same process as that performed when certain one or more of said built-in buttons are entered if said converted input information matches said input information to said certain one or more of said built-in buttons.
